(19) United States
(12) Patent Application Publication
(10) Pub. No.: US 2025/0202218 A1
(43) Pub. Date: Jun. 19, 2025

(54) METHOD FOR PROTECTING AGAINST FAULT ARCS

(71) Applicant: Siemens Aktiengesellschaft, München (DE)

(72) Inventors: Wolfgang Erven, Amberg (DE); Karsten Wenzlaff, Dresden (DE); Yi Zhu, Kümmersbruck (DE)

(21) Appl. No.: 18/847,795

(22) PCT Filed: Mar. 2, 2023
(86) PCT No.: PCT/EP2023/055300

§ 371 Date: Sep. 17, 2024

(30) Foreign Application Priority Data
Mar. 17, 2022 (DE) 10 2022 202 651.9

(51) Int. Cl. H02H 1/00; H02H 3/10; H02H 7/26

(52) U.S. Cl. CPC H02H 1/0015; H02H 3/10; H02H 7/26

(57) ABSTRACT

A method protects against fault arcs in an electric power distribution system in which electric power from an electric feed point is distributed via a common superordinate main distribution line and from the common main distribution line via multiple subordinate output lines. The main distribution line can be interrupted by a main switch, and each of the output lines can be interrupted by a paired output switch. A fault arc current threshold which, when exceeded by a fault arc current of a fault arc, is a precondition for triggering the main switch is matched to the maximum forward current and/or the output trigger duration of the output switches such that a fault arc is quenched selectively either by one of the output switches or by the main switch before the energy released by the fault arc exceeds a specified energy threshold.

The present invention relates to a method for protecting against arc faults, to an arc fault protection unit and to an electrical energy distribution installation.

Arcs can occur during operation, either in the form of a useful or working arc (e.g. as an ignition aid, in arc welding, in an arc furnace or in an arc lamp) or in the form of a switching arc that occurs during a switching operation between the contacts of a mechanical switch. If an arc does not occur during operation, but rather in an undesirable or unexpected manner as a result of a fault, this is referred to as an arc fault or arcing fault. Particularly in powerful distribution and switchgear installations, arc faults can lead to devastating destruction of equipment, installation parts or complete switchgear installations. In order to reduce damage and avoid a prolonged failure of the energy supply, it is necessary to detect and extinguish arc faults, in particular high-current or parallel arc faults, in a few milliseconds (≤5 ms) using an arc fault protection system.

An arc fault protection system can lead to a decision conflict regarding the priority of the protective mechanisms in a switchgear installation. An arc fault protection system has priority over all other protective mechanisms of the switchgear installation, as a result of its task of rapidly detecting an arc fault and immediately extinguishing it by interrupting the current in a superordinate area of the switchgear installation. A short-circuit algorithm of a circuit breaker that detects an arc fault in a subordinate area of the switchgear installation (outgoing feeder or outgoing branch circuit) associated with it as a short circuit is therefore overriden by the arc fault protection system. The selectivity in the switchgear installation, namely the selective shutdown of the outgoing branch circuit, hereinafter also referred to as the outgoing feeder, in which there is a short circuit, without intervention in fault-free adjacent outgoing branch circuits, is thus overruled.

However, the absolute priority of the arc fault protection system, which is primarily designed for high arc energies in a superordinate area of a switchgear installation, for example close to a point where electrical energy is fed into the switchgear installation, is not always the best solution for another reason. In the case of many arc fault events, the arc goes out again automatically after a very short time, since the energy released is too low to be able to maintain the arc permanently. The damage caused by the arc fault can be relatively small in these cases, e.g. limited to a damage pattern with arc roots, relatively small molten spots and small traces of smoke, while the actual, far more expensive damage only arises when the entire switchgear installation is shut down, which was initiated by the arc fault protection system.

There is therefore a need for an improved arc fault protection system.

The object is achieved by a method as claimed in claim 1.

The object is also achieved by an arc fault protection unit as claimed in claim 11.

The method according to the invention is used to protect against arc faults in an electrical energy distribution installation. The energy distribution installation has an electrical feed-in point at which electrical energy, which is provided by an electrical energy source, e.g. a multiphase power supply, is fed into the energy distribution installation. A transformer may be provided at the feed-in point and performs a voltage conversion, usually from a higher voltage of the electrical energy source to a lower voltage in the energy distribution installation. In addition, the energy distribution installation has a superordinate common main distribution line and a plurality of subordinate outgoing feeder lines. In the energy distribution installation, electrical energy is distributed from the electrical feed-in point via the main distribution line and from the main distribution line via the outgoing feeder lines to electrical loads. The electrical energy distribution installation is also referred to below as a distribution network. The electrical energy distribution installation can be, for example, a switchgear installation or another circuit for distributing electrical energy from a feed-in point to electrical loads. The main distribution line can be interrupted by a main switch and the outgoing feeder lines can each be interrupted by an associated outgoing feeder switch. The main switch can be designed as a protective switching device, e.g. a circuit breaker, or a short-circuiting device. The main switch can also be designed as a series circuit comprising a protective switching device, e.g. a circuit breaker, and a short-circuiting device. The outgoing feeder switches can be designed as protective switching devices such as ACB, MCB, MCCB or a fuse (ACB=Air Circuit Breaker; MCB=Miniature Circuit Breaker; MCCB=Molded Case Circuit Breaker). This defines a first protection area of the energy distribution installation, which is located between the main switch and the outgoing feeder switches, and a second protection area of the energy distribution installation, which is located downstream of the outgoing feeder switches in the direction of energy transport. An arc fault current threshold value, the exceeding of which by an arc fault current of an arc fault is a prerequisite for tripping the main switch in order to extinguish the arc fault, is matched to the maximum forward current of the outgoing feeder switches and/or the outgoing feeder tripping duration of the outgoing feeder switches such that an arc fault is extinguished either selectively by one of the outgoing feeder switches or by the main switch before the energy released by the arc fault exceeds a predefined energy threshold value. Selective fault resolution means in relation to the energy distribution installation described above
a) that, in the event of an arc fault in the second protection area, the outgoing feeder switches are first given the opportunity to extinguish this arc fault by tripping an outgoing feeder switch upstream of the arc fault before the main switch is tripped;
b) that, in the event of an arc fault in the first protection area, the main switch is tripped, and
c) that it is ensured that an arc fault is extinguished before the energy released by the arc fault in the energy distribution installation exceeds the defined energy threshold value.

The occurrence of an arc fault in the energy distribution installation is also simply referred to below, in a similar manner to the designation of an arc fault as an arcing fault, as a fault event or for short as: a fault.

One idea on which the invention is based is to supplement a protection algorithm used by an arc fault protection system in such a way that the protection algorithm takes into account an energy threshold value that must not be exceeded for the released arc fault energy. The energy threshold value corresponds to the maximum tolerable level of damage in the energy distribution installation. If an arc fault occurs, an attempt should first be made to selectively extinguish the arc fault, i.e. by means of one of the outgoing feeder switches, before the superordinate main switch is tripped. Delaying the tripping of the main switch is advantageous in that in many cases, as already mentioned in the introduction of the description, the actual damage does not occur due to the arc fault itself, but only due to the shutdown of the entire switchgear installation. However, in order to comply with the energy threshold value, the energy released into the installation by the arc fault is not continuously compared with the energy threshold value, but rather, according to the present invention, during the planning or design of the energy distribution installation, the arc fault current threshold value in the main switch is determined on the basis of the energy threshold value in such a way that that the arc fault current threshold value is exceeded before the energy threshold value is exceeded. In the main switch itself or a control unit tripping the main switch, this energy threshold value is thus stored only in the form of this arc fault current threshold value.

According to the invention, the arc fault is thus extinguished before the energy released by the arc fault exceeds a predefined energy threshold value. An arc fault protection algorithm detects a fault event but can hold off on tripping the main switch to trip for as long as the damage can be tolerated (a high arc fault current threshold value is equivalent to a long time delay in the tripping of the main switch). The algorithm thus first gives the subordinate outgoing feeder switches the opportunity to resolve the fault located there, without the entire energy distribution installation being shut down by default as before. The algorithm for arc fault protection is extended by a waiting time, i.e. a delay of the main switch, in order to ensure selectivity. Two different events can thus be distinguished: a) “Selective tripping of one of the outgoing feeder switches in order to extinguish an arc fault in a subordinate level of the energy distribution installation” and b) “Tripping of the main switch in order to extinguish an arc fault in a superordinate level of the energy distribution installation or as a fallback solution in order to prevent the energy released by the arc fault from exceeding a predefined energy threshold value”. The conventional methods of selectivity are extended by the energy criterion of maximum tolerable damage in the event of an arc fault event. The term “level” of the energy distribution installation should not be construed as limiting the structure of the energy distribution installation; it should simply be regarded as an area, in particular a protection area, of the energy distribution installation. The term “level” considers the energy distribution installation from a more hierarchical perspective, while the term “area” rather emphasizes the grid-like structure of the energy distribution installation. It is essential that electrical energy, which is intended to reach a subordinate level or a subordinate area of the energy distribution installation from the feeding point, must pass through the superordinate level or the superordinate area. Thus, an interruption of the current in the main line in the superordinate level or in the superordinate area causes no more current to flow in the subordinate levels or in the subordinate areas of the energy distribution installation either.

In the case of arc fault protection systems whose detection is based on current and voltage, selectivity could previously only be guaranteed up to the level of the arc fault current threshold value. This arc fault current threshold value is based on the measuring point near the feed-in point and is usually determined according to the requirements for protection of the main busbar system, i.e. the main line in the superordinate level of the energy distribution installation. If known arc fault protection algorithms, namely the combination of voltage detection methods and an arc fault current threshold value, are now combined according to the invention with that of an energy observation, then tripping or non-tripping of lower distribution levels can be controlled in a much more differentiated manner and selectivity can be thus guaranteed.

In the case of conventional protective devices, the tripping characteristic curves and the current threshold values in the protective devices are determined by the manufacturer of the protective devices; moreover, the protective devices are not usually configurable for different applications. The invention now allows the current/time characteristic curve of the protective devices and the energy threshold value to be adapted depending on the application in which the protective devices are intended to be used.

The arc fault protection unit according to the invention is adapted for use in an electrical energy distribution installation. It has an interface for receiving electrical voltage and/or current values measured in the energy distribution installation and for sending signals to a main switch. It also has a data memory for storing a predefined arc fault current threshold value above, which the main switch is tripped. It also has a processor that is configured to detect an arc fault burning in the energy distribution installation on the basis of electrical voltage and/or current values of the energy distribution installation, and to trip the main switch if the arc fault current of the arc fault measured at the main switch exceeds the arc fault current threshold value or before the energy released by the arc fault exceeds a predefined energy threshold value.

According to the invention, the arc fault current threshold value is determined such that it is less than a maximum arc fault current in the main distribution line. This ensures that the arc fault current threshold value is always reached and that the main switch is thus tripped if the arc fault burns in the first protection area or the energy threshold value is reached.

Advantageous configurations and developments of the invention are specified in the dependent claims. In this case, the method according to the invention can also be developed according to the dependent device claims and vice versa.

According to one preferred configuration, the arc fault current threshold value is selected to be greater than the maximum forward current of the outgoing feeder switches if the outgoing feeder switches are current-limiting.

According to one preferred configuration, the arc fault current threshold value is determined such that the time interval until the arc fault current threshold value is reached is less than the time interval until the energy threshold value is reached. This ensures that the arc fault is extinguished before the energy released by it in the energy distribution installation exceeds the energy threshold value. The main switch serves here as a fallback solution for extinguishing the arc fault if the outgoing feeder switches were not able to extinguish the arc fault.

According to one preferred configuration, the main distribution line is interrupted by the main switch after a shutdown duration after receiving a shutdown command, and the outgoing feeder switches are configured to trip according to a respective time/current characteristic curve of the outgoing feeder switches, which defines a relationship between a maximum forward current of the outgoing feeder switch and an outgoing feeder tripping duration of the outgoing feeder switch. In a first case, in which the sum of in each case an outgoing feeder tripping duration of the outgoing feeder switches and the shutdown duration of the main switch is less than the time interval until the energy threshold value is reached, a waiting time is determined, during which tripping of the main switch is blocked. This waiting time is used to give the subordinate outgoing feeder switches of the energy distribution installation the opportunity to selectively extinguish the arc fault. This waiting time is determined to be at least as long as the outgoing feeder tripping duration and is also determined such that the energy released by the arc fault does not exceed the predefined energy threshold value.

The shutdown duration of the main switch is the period of time that the main switch needs to interrupt the current in the main distribution line after a trip command has been received, its response time, as it were.

The arc fault protection algorithm can be adapted in such a way that, depending on the arc energy level in the different distribution levels of the energy distribution installation, the trip signal to the main switch is delayed and 8 initially, at the latest by the time at which the energy threshold value is reached, an outgoing feeder switch of a lower distribution level is given time to resolve the fault. The selectivity in the energy distribution installation can thus be guaranteed up to a defined level of damage.

During the predefined waiting time of the main switch, the outgoing feeder switches are given the opportunity to selectively extinguish the arc fault. The waiting time of the main switch is determined in such a way that the energy released by the arc fault does not exceed a predefined energy threshold value, regardless of whether the arc fault is ultimately intended to be extinguished by tripping one of the outgoing feeder switches or the main switch.

Thus, depending on which energy released by the arc fault in the energy distribution installation is tolerable in the energy distribution installation, the trip signal from the arc fault protection unit to a main switch in a superordinate level of the energy distribution installation (also referred to as protection area I) can be delayed and during this time an outgoing feeder switch in a subordinate level of the energy distribution installation (also referred to as protection area II) can be given time to resolve the fault, i.e. the arc fault, before the trip signal from the arc fault protection unit to the main switch causes the entire energy distribution installation to be shut down. The selectivity in the energy distribution installation can thus be guaranteed up to a defined level of damage, corresponding to the tolerated energy release of the arc fault. Depending on the variables of the switchgear installation, e.g. feed-in power and distribution design, and the shutdown behavior of the protective devices, e.g. current limitation, tripping and shutdown times, the selectivity behavior of the protective switching devices in the energy distribution installation is coordinated. The tolerable energy threshold value is converted into a time delay, i.e. a waiting time of the arc fault protection system (=arc fault protection unit and main switch), (for a corresponding arc fault current threshold value) and compared with the tripping behavior of an outgoing feeder switch. If the possible waiting time of the arc fault protection system is now greater than the tripping duration of the outgoing feeder switch and if the current limitation is sufficient in relation to the arc fault current threshold value, there is selectivity. This selectivity is planned and designed into the installation. It is also possible to send the parameters to the respective protective device as a trip or blocking signal by means of signal or reporting selectivity. The detection algorithm for arc fault protection is extended by a waiting time in order to ensure selectivity.

According to one preferred configuration of the first case, the arc fault current threshold value and the waiting time are determined according to the time/current characteristic curve of the outgoing feeder switches and according to the time interval/electrical power characteristic curve, which defines a relationship between the time interval until the energy threshold value is reached and the feed-in power at the feed-in point. The higher the feed-in power, the faster the tolerable arc fault energy is reached. If the sum of in each case an outgoing feeder tripping duration of the outgoing feeder switches and the shutdown duration of the main switch is not less than the time interval until the energy threshold value is reached, no waiting time of the main switch may be provided. Instead, the decision to trip a switch in order to extinguish the arc fault should be made on the basis of the arc fault current threshold value of the main switch or using reporting selectivity.

According to one preferred configuration of the first case, if, after the waiting time has elapsed, the current measured at the main switch is greater than the arc fault current threshold value of the main switch, the main switch is tripped. A fault current remaining after the waiting time indicates the presence of one of the two following situations a) and b): a) The fault is present in protection area I=> the main switch must be tripped; b) The fault is present in protection area II, but has not been successfully cleared by the outgoing feeder switch=> the main switch must be tripped as a backup.

According to one preferred configuration, the main distribution line is interrupted by the main switch after a shutdown duration after receiving a shutdown command, and the outgoing feeder switches are configured to trip according to a respective time/current characteristic curve of the outgoing feeder switches, which defines a relationship between a maximum forward current of the outgoing feeder switch and an outgoing feeder tripping duration of the outgoing feeder switch, wherein, in a second case, in which the sum of in each case an outgoing feeder tripping duration of the outgoing feeder switches and the shutdown duration of the main switch is greater than or equal to the time interval until the energy threshold value is reached, the arc fault current threshold value is determined such that the arc fault current threshold value is greater than the maximum forward current of the outgoing feeder switches, and the time interval until the arc fault current threshold value is reached is less than the time interval until the energy threshold value is reached.

According to one preferred configuration of the second case, assuming all outgoing feeder switches have current limitation, the main switch is tripped if the current measured at the main switch is greater than the arc fault current threshold value of the main switch.

According to one preferred configuration of the second case, assuming that one or more outgoing feeder switches do not have current limitation, the main switch is tripped if the current measured at the main switch is greater than the arc fault current threshold value of the main switch and the current measured at the outgoing feeder switches is not greater than the short-circuit tripping threshold of the outgoing feeder switches. It is advantageous if the criterion regarding whether the current measured at the outgoing feeder switches is not greater than the short-circuit tripping threshold of the outgoing feeder switches is checked at the outgoing feeder switches; for this purpose, the outgoing feeder switches may have a current measuring device for measuring the current at the outgoing feeder switches, and a processor which compares a current value measured by the current measuring device at the outgoing feeder switch with a short-circuit tripping threshold of the outgoing feeder switches. In this case, if the current measured at an outgoing feeder switch is greater than the short-circuit tripping threshold of the outgoing feeder switch, the outgoing feeder switch can send a blockage signal to the main switch or to an arc fault protection unit controlling tripping of the main switch. In order to distinguish between F1 and F2, the current limitation and the response time of the outgoing feeder switches are therefore used as additional criteria for selecting the arc fault current threshold value and the delay time of the main switch.

According to one preferred configuration, the arc fault is detected on the basis of electrical voltage and/or current values of the energy distribution installation. The arc fault can be detected by means of an algorithm for detecting arc faults, which evaluates the voltage and current values of the distribution network.

In this case, the arc fault protection unit, a capture device, e.g. a current and/or voltage sensor, which is configured to capture electrical voltage and/or current values of the distribution network and to send them to the arc fault protection unit, and an arc fault circuit breaker, referred to in this description as the main switch, which is configured to interrupt a current in the distribution network after receiving a trip signal from the arc fault protection unit for extinguishing the arc fault, form an arc fault protection system.

In the arc fault protection system, a waiting time corresponding to the arc energy is derived, depending on the expected level of damage. This means that the actual triggering and resolution of the fault in a superordinate level of the distribution network is no longer undelayed, but rather dependent on the arc energy (=damage energy).

According to one preferred configuration, said waiting time relates to tripping of an arc fault circuit breaker, referred to as the main switch, in a superordinate level of the distribution network, whereas undelayed tripping in response to overcurrent and short-circuit current is enabled for protective switching devices in subordinate levels of the distribution network.

Supplementing the tripping algorithm with an energy-dependent threshold value or a waiting time dependent thereon makes it possible to avoid unplanned spontaneous shutdown of the distribution network, which would leave intolerable damage behind. The distribution network can continue to be operated and an unplanned installation downtime can be avoided. The fault can be searched for at a later scheduled time. A further advantage is the scalability of the arc fault current threshold value which can be adapted to the respective conditions and design variables of the distribution network, e.g. feed-in power, and topologies, e.g. size of the outgoing feeders, cooling effect of busbars.

Another advantage is that arc faults, e.g. short circuits, in subordinate distribution levels, which are protected by the protective switching devices provided for this purpose in the outgoing feeders, are not overridden by the arc fault circuit breaker and there is no shutdown of the entire distribution network.

A further aspect of the invention is an electrical energy distribution installation in which electrical energy is distributed from an electrical feed-in point via a superordinate common main distribution line and from the common main distribution line via a plurality of subordinate outgoing feeder lines, wherein the main distribution line can be interrupted by a main switch and the outgoing feeder lines can each be interrupted by an associated outgoing feeder switch. In this case, the energy distribution installation has at least one sensor for determining voltage and/or current values in the main distribution line and an arc fault protection unit, as described above.

In the case of conventional arc fault protection systems whose detection is based on current and voltage, selectivity could only be guaranteed up to the level of the limit value for the current threshold. This threshold value is based on the measuring point near the feed-in point and is determined according to the requirements for protection of the main busbar system. If the known algorithm, namely the combination of voltage detection methods and an the limit value of a current threshold, is combined according to the invention with that of an energy observation, then tripping or non-tripping of lower distribution levels can be controlled in a much more differentiated manner and selectivity can be thus guaranteed. The process can be as follows: Depending on the level of damage that can be tolerated in the energy distribution installation, the corresponding energy threshold value is determined, e.g. up to 100 kJ. Depending on the variables of the switchgear installation, e.g. feed-in power and distribution design, and depending on the shutdown behavior of the outgoing feeder switches, e.g. current limitation and tripping and shutdown times, the required selectivity behavior is now coordinated. The tolerable energy threshold value is converted into a time delay, i.e. a waiting time or delay of the arc fault protection unit tripping the main switch, depending on the selected arc fault current threshold value and compared with the tripping behavior of a protective switching device in a subordinate level of the electrical distribution network. For reasons of selectivity, the arc fault current threshold value is preferably above the tripping thresholds of the outgoing feeder switches. If, due to the desired delay, the possible trip command from the arc fault protection unit occurs later than the tripping of a protective switching device in a subordinate level and if the current limitation is sufficient with regard to said current threshold of the protective switching device, there is selectivity. This selectivity is planned, and the energy distribution installation is designed accordingly.

During the design and planning phase of the electrical energy distribution installation, a decision must be made, in each case for the first case and the second case, as to whether the main switch or one of the outgoing feeder switches is intended to be tripped; two different procedures are proposed depending on the short-circuit power, since there are different time requirements for different short-circuit power ranges. These time requirements are derived from an energy observation of the maximum tolerable damage, e.g. 100 kJ:
In a first, lower short-circuit power range (relatively small to moderate feed-in power, i.e. small to moderate short-circuit current), the outgoing feeder switch is given the time to resolve F2,
In a second, upper short-circuit power range (relatively large feed-in power, i.e. large short-circuit current), the fault location is determined on the basis of the maximum fault current that occurs.

According to one preferred configuration, trip or blocking signals are exchanged between the main switch and/or the outgoing feeder switches within the framework of signal or reporting selectivity. These trip or blocking signals can be based on parameters such as times, current and/or voltage and integral variables. Reporting selectivity or signal selectivity is based on the fact that at least two switches exchange their future switching state and can thus block or trip each other. This means that one switch waits for the signal from the other before performing an operation. The opening behavior of switch cascades is conventionally controlled using reporting selectivity. The ZSI functionality for more sluggish MCCBs and ACBs is such reporting selectivity (ZSI=Zone Selectivity Interlocking).

The type of selectivity according to the invention is particularly suitable for the protection system on one of the subordinate distribution levels, since here already a greatly reduced short-circuit current and rapid opening of the protective switching devices coincide with strong current limitation. Low arc energies are released and lead to tolerable damage patterns.

The above-described properties, features and advantages of this invention and the manner in which these are achieved become clearer and more clearly understandable by means of the following description which is explained in more detail with reference to the drawing, in which, schematically and not to scale in each case:

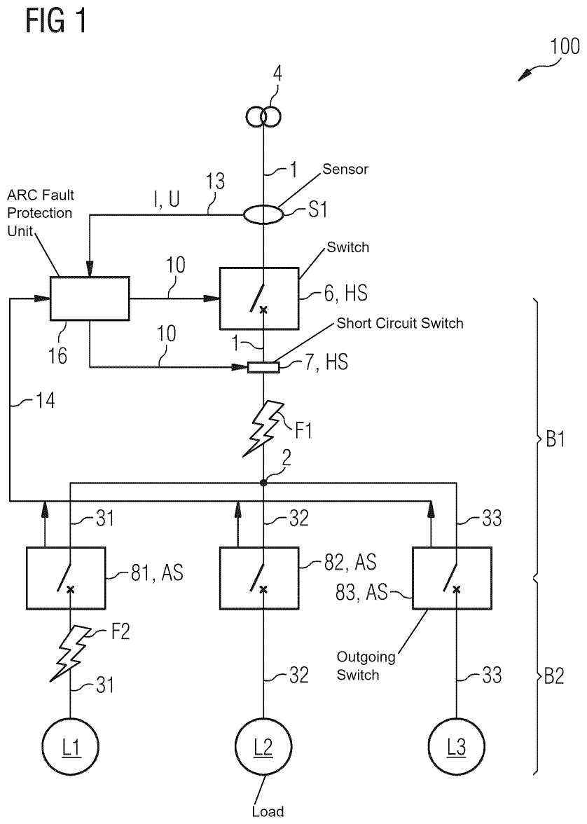

FIG. 1 shows an electrical energy distribution installation;

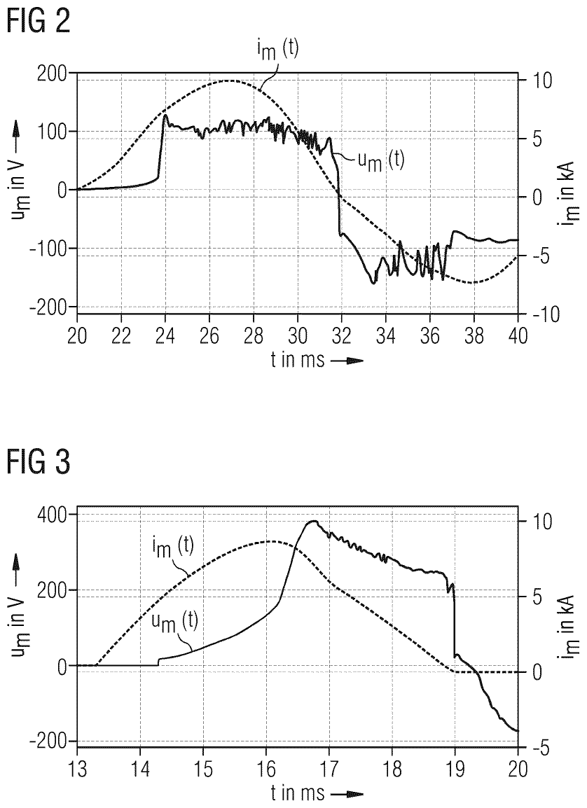

FIG. 2 shows a first diagram of the temporal voltage and current profile in the case of an arc fault ignition,

FIG. 3 shows a first diagram of the temporal voltage and current profile in the case of a switching arc ignition,

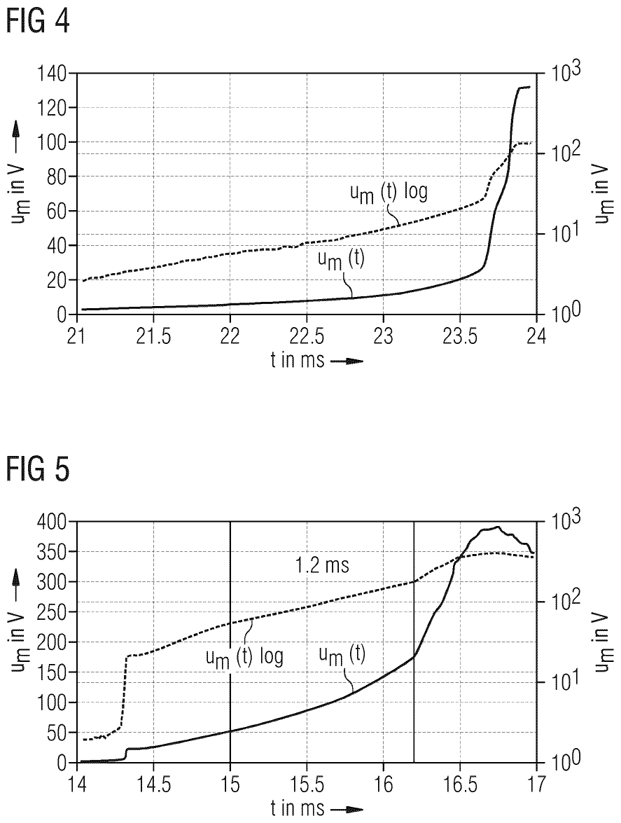

FIG. 4 shows a semilogarithmic diagram of the temporal voltage profile in the case of an arc fault ignition,

FIG. 5 shows a semilogarithmic diagram of the temporal voltage profile in the case of a switching arc ignition,

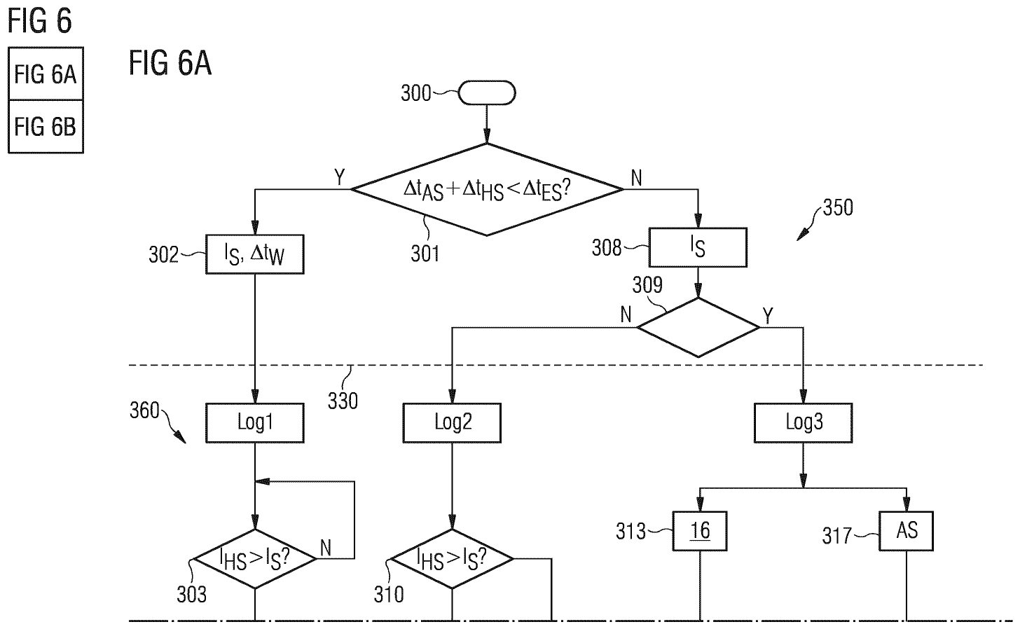

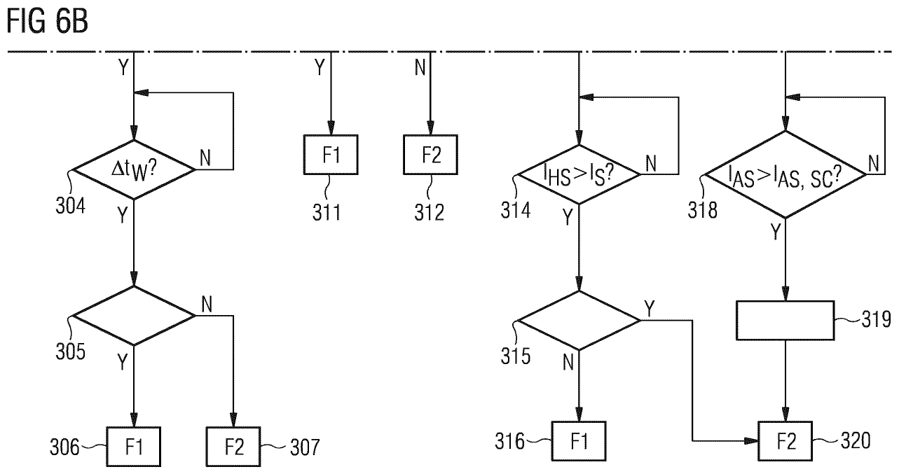

FIG. 6 shows a flowchart of an algorithm for performing a method according to the invention; and

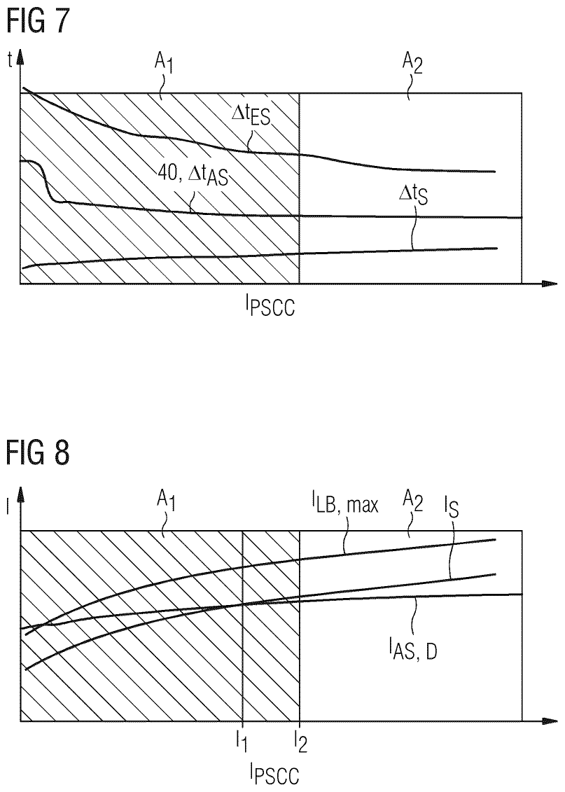

FIG. 7 shows an I-t diagram of different periods of time against the maximum short-circuit current;

FIG. 8 shows an I-I diagram of different current values against the maximum short-circuit current;

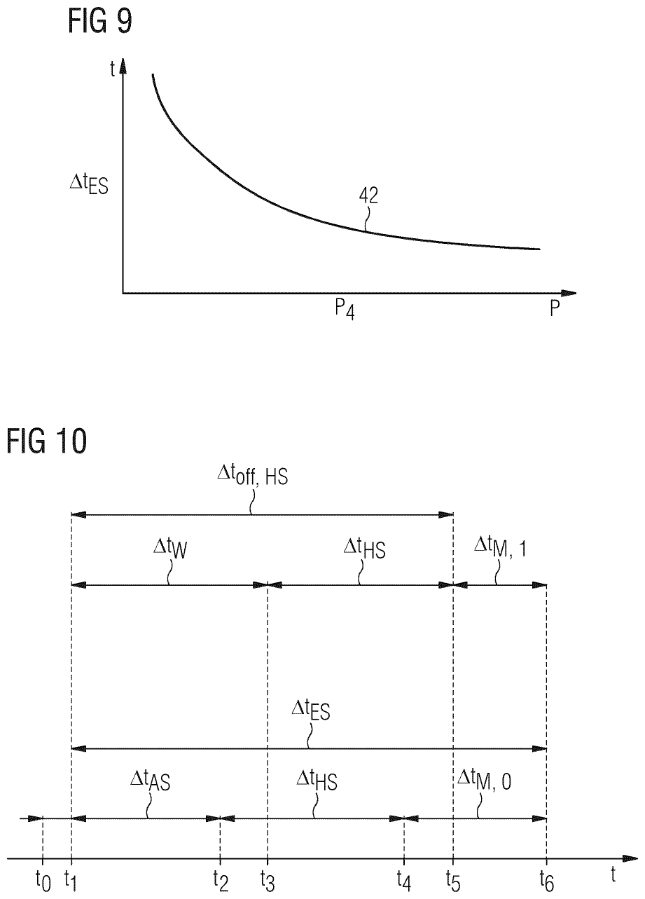

FIG. 9 shows a P-t diagram of the period of time until the energy threshold value is reached against the transformer power; and

FIG. 10 shows a time line on which different times and periods of time are indicated.

FIG. 1 shows an electrical distribution network in the form of an electrical energy distribution installation 100 in which electrical energy is conducted from a feed-in point 4 via a superordinate common main distribution line 1. The common main distribution line 1 branches at a branching point 2 into three subordinate outgoing feeder lines 31, 32, 33 which each conduct the electrical energy provided at the feed-in point 4 to an electrical load L1, L2, L3, for example electric motors.

The common main distribution line 1 and the outgoing feeder lines 31, 32, 33 may be designed for a single-phase or a multi-phase power line from the feed-in point 4 to the electrical loads L1, L2, L3. For a single-phase power line, it is sufficient if the lines 1, 31, 32, 33 each have a single current conductor, and optionally a current return conductor or a neutral conductor. For a three-phase power line, i.e. in a three-phase grid for three-phase alternating current, it is sufficient if the lines 1, 31, 32, 33 each have three separate current conductors-one conductor each for one of the three current phases; in addition, a neutral conductor may be present.

A main switch HS having a circuit breaker 6, HS and a short-circuiting device 7, HS, which are connected in series, is connected into the main distribution line 1. The main distribution line 1 can be interrupted by the circuit breaker 6, which is designed, for example, as an ACB (=Air Circuit Breaker), and short-circuited by the short-circuiting switch 7; in both cases, an arc that burns in the energy distribution installation 100 is extinguished. In alternative embodiments, only a circuit breaker 6 or only a short-circuiting device 7 is connected into the main distribution line 1.

The outgoing feeder lines 31, 32, 33 can each be interrupted by an associated protective switching device 81, 82, 83-hereinafter also referred to as outgoing feeder switch AS. The protective switching devices 81, 82, 83 can be designed as a circuit breaker, e.g. an ACB, an MCCB, an MCB or a fuse.

The distribution network between the main switch HS and the outgoing feeder switches AS forms a superordinate level B1 of the electrical energy distribution installation 100, the so-called main level, which is also referred to as the first protection area. The distribution network in the energy transport direction downstream of the outgoing feeder switches forms a subordinate level B2 of the electrical energy distribution installation 100, the so-called lower distribution level or outgoing feeder level, which is also referred to as the second protection area.

In the main distribution line 1, a sensor S1 for determining measured values of current I and voltage U is arranged in the main distribution line 1. The sensor S1 is connected to a sensor line 13 for transmitting the measured values I, U captured by the sensor S1 to an arc fault protection unit 16 which is also referred to as PADD (=Parallel Arc Detection Device). From the arc fault protection unit 16, control lines 10 run to the main switch 6 and the short-circuiting device 7 for transmitting control signals, e.g. a trip signal or a blockage signal, from the arc fault protection unit 16 to the main switch 6 and the short-circuiting device 7. Each of the outgoing feeder switches AS can send signals to the arc fault protection unit 16 via a signal line 14 of the energy distribution installation 100.

The arc fault protection unit 16 is configured to detect the burning of an arc fault F1, F2, which can burn at any points in the energy distribution installation 100, on the basis of electrical voltage and current values measured by the sensor S1 in the main distribution line 1.

In a circuit or network in which an arc is burning, a current and voltage profile with a significant profile can be measured. A typical temporal voltage profile uₘ (t) and temporal current profile iₘ (t) for an arc fault are shown in FIG. 2. This shows a diagram illustrating the temporal profile of the electrical voltage U and the electrical current I after ignition of an arc or arc fault, in particular parallel arc faults, in an electrical circuit, in particular a low-voltage circuit.

The time t in milliseconds (ms) [t in ms] is shown on the horizontal X-axis. The magnitude of the electrical voltage Uₘ in volts (V) [uₘ in V] is shown on the vertical Y-axis on the left-hand scale. The magnitude of the electrical current iₘ in kiloamperes (kA) [iₘ in kA] is shown on the right-hand scale.

After arc ignition, the current I continues with an approximately sinusoidal profile. The voltage U has a very distorted profile, approximately “jagged”, with rapid voltage changes. Roughly interpreted, the voltage profile has a square-wave form to a first approximation, instead of a normally sinusoidal profile. When considered in abstraction, a square-wave form that exhibits a highly stochastic component on the plateau can be seen in the voltage profile. The square-wave form is characterized in that, during arc ignition and at the subsequent voltage zero crossings of the AC voltage, significantly increased voltage changes occur, which are subsequently referred to as a voltage jump, since the increase in the voltage change is much greater in comparison with a sinusoidal voltage profile.

FIG. 3 shows a diagram of the temporal voltage and current profile according to FIG. 2, with the difference of switching arc ignition.

If the profiles according to FIGS. 2 and 3 are represented semilogarithmically, then the behavior that is typical of a switching arc and deviates from the arc fault is manifested in the voltage profile according to FIGS. 4 and 5.

FIG. 4 shows an illustration of the temporal voltage profile uₘ (t), Uₘ (t) log in the case of arc fault ignition according to FIG. 2, on the one hand in a linear representation uₘ (t) and on the other hand in a semilogarithmic representation uₘ (t) log. The time t in milliseconds (ms) [t in ms] is shown on the horizontal X-axis. The magnitude of the electrical voltage uₘ in volts (V) [uₘ in V] is shown in a linear representation on the vertical Y-axis on the left-hand scale. The magnitude of the electrical voltage uₘ in volts (V) [uₘ in V] is shown in a logarithmic representation on the right-hand scale.

FIG. 5 shows a diagram according to FIG. 4, with the difference of switching arc ignition.

In a circuit or network, it is therefore possible to detect the burning of an arc fault on the basis of the current and voltage values. Such a method is described, for example, in DE 10 2016 209 445 A1 (Siemens AG; TU Dresden) 2017.11.30.

FIG. 1 shows two different situations. In a first scenario shown in FIG. 1, an arc fault F1 is burning in the superordinate level B1 of the energy distribution installation 100, namely in the main distribution line 1 between the main switch 1 and the branching point at which the main distribution line 1 branches into the outgoing feeder lines 31, 32, 33. In a second scenario shown in FIG. 1, an arc fault F2 is burning in the subordinate level B2 of the energy distribution installation 100, namely in the left-hand outgoing feeder line 31 between the branching point, at which the main distribution line 1 branches into the outgoing feeder lines 31, 32, 33, and the first load L1 supplied with electrical energy by the left-hand outgoing feeder line 31. In both scenarios, the sensor S1 of the main distribution line 1 measures the measured values of current I and voltage U, which are characteristic of an arc fault and are transmitted via the sensor line 13 to the arc fault protection unit 16.

FIG. 6 shows a flowchart which can be realized, for example, in the form of an algorithm. The flowchart is divided into a planning and design phase 350 and a working phase 360 by a dividing line 330.

After starting 300 the planning and design phase 350, a check is carried out in a first step 301 in order to determine whether the sum of the tripping duration Δt_{AS} of the outgoing feeder switches AS and the shutdown duration Δt_{HS} of the main switch HS is less than the period Δt_{ES} until a predefined energy threshold value E_{S} is reached. In this case, the energy threshold value E_{S} is that damage energy which is released by an arc fault and can be maximally tolerated. An operator of the energy distribution installation must determine this energy threshold value E_{S}.

If the answer is yes (Y) (sum of the tripping duration Δt_{AS} of the outgoing feeder switches AS and the shutdown duration Δt_{AS} of the main switch HS<period Δt_{ES} until a predefined energy threshold value E_{S} is reached), this may indicate that a relatively small short-circuit power is being fed in. In this case, in step 302, the arc fault current threshold value I_{S} of the main switch HS and the waiting time Δt_{W} of the main switch HS are determined according to the time/current characteristic curve 40 of the outgoing feeder switches, see FIG. 7, and according to the period Δt_{ES} until the energy threshold value E_{S} is reached, which can be taken from the time interval/electrical power characteristic curve 42, see FIG. 9, which defines a relationship between the time interval Δt_{ES} until the energy threshold value E_{S} is reached and the feed-in power P₄ at the feed-in point 4. Both variables, the arc fault current threshold value I_{S} and the waiting time Δt_{W} of the main switch HS, depend on the feed-in power at the feed-in point. The waiting time Δt_{W} of the main switch HS is determined to be greater than or equal to the tripping duration Δt_{AS} of the outgoing feeder switches AS. At this point, the planning and design phase 350 ends in this branch; in the working phase 360, first overcurrent detection logic Log1 is subsequently used in the arc fault protection unit 16.

If the answer is no (N) (sum of the tripping duration Δt_{AS} of the outgoing feeder switches AS and the shutdown duration Δt_{AS} of the main switch HS>=period Δt_{ES} until a predefined energy threshold value E_{S} is reached), this may indicate that a relatively large short-circuit power is being fed in. In this case, in step 308, the arc fault current threshold value I_{S} of the main switch HS is determined such that the arc fault current threshold value I_{S} is greater than the maximum forward current I_{AS,D} of the current-limiting outgoing feeder switches AS, 81, 82, 83 and the time interval Δ_{tS} until the arc fault current threshold value I_{S} is reached is less than the time interval Δt_{ES} until the energy threshold value E_{S} is reached. In the next step 309, a distinction is made as to whether all outgoing feeder switches AS, 81, 82, 83 have current limitation. ACBs have no current limitation. MCCBs have clear current limitation depending on the short-circuit power for small sizes: the greater the short-circuit power, the more pronounced the current limitation becomes. In addition, the larger the size, the lower the current limitation is for MCCBs. MCBs generally have very strong current limitation. A fuse covers MCBs and MCCBs.
If all outgoing feeder switches AS, 81, 82, 83 have current limitation, the arc fault current threshold value is designed to be just above the maximum current limitation of the outgoing feeder switches. At this point, the planning and design phase 350 ends in this branch; in the working phase 360, second overcurrent detection logic Log2 is subsequently used in the arc fault protection unit 16.
If one or more of the outgoing feeder switches AS, 81, 82, 83 have no current limitation, a blockage signal from these outgoing feeder switches to the arc fault protection unit 16 is required in each case in the working phase 360 following the planning and design phase 350. The arc fault current threshold value is designed to be just above the maximum current limitation of the current-limiting outgoing feeder switches. At this point, the planning and design phase 350 ends in this branch; in the working phase 360, third overcurrent detection logic Log3 is subsequently used in the arc fault protection unit 16.

The working phase 360 is described below.

The working phase 360 begins as soon as it is detected, on the basis of current and/or voltage values of the main distribution line 1, that an arc fault is burning in the energy distribution installation 100.

The first overcurrent detection logic Log1 in the arc fault protection unit 16 queries in a first step 303 whether the current Is measured at the main switch HS is greater than the arc fault current threshold value I_{S} of the main switch HS. This query 303 is run through (query loop N) until the current I_{HS} measured at the main switch HS is greater than the arc fault current threshold value I_{S} of the main switch HS (Y). In a subsequent step 304, it is queried whether the waiting time Δt_{W} of the main switch HS has expired. This query 304 is run through (query loop N) until the waiting time Δt_{W} of the main switch HS has expired. In a subsequent step 305, it is queried whether the sensor S1 is still measuring overcurrent in the main distribution line 1. If so (Y), there is an arc fault F1 in the first protection area (306). If not (N), there is an arc fault F2 in the second protection area (307). The second overcurrent detection logic Log2 (outgoing feeder switches AS, 81, 82, 83 with current limitation) in the arc fault protection unit 16 queries in a first step whether the current Is measured at the main switch HS is greater than the arc fault current threshold value I_{S} of the main switch HS. If so (Y), there is an arc fault F1 in the first protection area (311). If not (N), there is an arc fault F2 in the second protection area (312).

The third overcurrent detection logic Log3 (outgoing feeder switches AS, 81, 82, 83 without current limitation) distinguishes between a sequence 313 of work steps that relate to the arc fault protection unit 16 or the main switch HS, and a sequence 317 of work steps that relate to the outgoing feeder switches AS, 81, 82, 83. The third overcurrent detection logic Log3 queries in a first step 314 whether the current I_{HS} measured at the main switch HS is greater than the arc fault current threshold value I_{S} of the main switch HS. This query 314 is run through (query loop N) until the current I_{HS} measured at the main switch HS is greater than the arc fault current threshold value I_{S} of the main switch HS (Y). In a parallel step 318, it is queried whether a current I_{AS} measured at an outgoing feeder switch AS, 81, 82, 83 is greater than the short-circuit tripping threshold I_{AS,SC} of the respective outgoing feeder switch AS, 81, 82, 83. This query 318 is run through (query loop N) until the current I_{AS} measured at the outgoing feeder switch AS, 81, 82, 83 is greater than the short-circuit tripping threshold I_{AS,SC} of the outgoing feeder switch AS, 81, 82, 83 (Y). In this case, in step 319, a blockage signal is sent from the outgoing feeder switch AS, 81, 82, 83 to the main switch HS or the arc fault protection unit 16, since there is an arc fault F2 in the second protection area (320).

In a step 315 following step 314, it is queried whether the arc fault protection unit 16 or the main switch HS has received a blockage signal from one of the outgoing feeder switches AS, 81, 82, 83. If the arc fault protection unit 16 or the main switch HS has received a blockage signal from one of the outgoing feeder switches AS, 81, 82, 83 (Y), there is an arc fault F2 in the second protection area (320). If the arc fault protection unit 16 or the main switch HS has not received a blockage signal from one of the outgoing feeder switches AS, 81, 82, 83 (N) and the current I_{HS} measured at the main switch HS is greater than the arc fault current threshold value I_{S} of the main switch HS (I_{HS}>I_{S}), there is an arc fault F1 in the first protection area (316).

FIG. 7 shows an I-t diagram of different periods of time as a function of the maximum short-circuit current I_{PSCC}. Δt_{ES} indicates the period from the ignition of an arc fault until the energy threshold value E_{S} is reached. Δt_{AS} indicates the tripping duration of the outgoing feeder switch AS in accordance with the tripping characteristic according to the time/current characteristic curve of an outgoing feeder switch AS after the current flowing through the outgoing feeder switch has reached a certain current intensity. Δt_{S} indicates the period until the arc fault current threshold value I_{S} is reached.

FIG. 8 shows an I-I diagram of different current values as a function of the maximum short-circuit current I_{PSCC}. I_{LB,max} is the maximum arc fault current; it is usually reduced by 30-50% compared to the maximum short-circuit current I_{PSCC} (prospective current). I_{S} is the arc fault current threshold value of the main switch HS. I_{AS,D} is the maximum forward current of the outgoing feeder switch: the highest current peak value allowed by a current-limiting outgoing feeder switch (=circuit breaker). In the two diagrams in FIG. 7 and FIG. 8, a distinction is made between a first power range A1 and a second power range A2. The upper limit of the first power range A1 on the I_{PSCC}axis in FIG. 8 is at the second threshold value I₂;

here, the power ranges in FIGS. 7 and 8 correspond to each other. The first threshold value In on the I_{PSCC} axis in FIG. 8 is that point at which the arc fault current threshold value I_{S} of the main switch HS exceeds the maximum forward current I_{AS,D} of the outgoing feeder switch AS and thus forms the mathematically correct limit line, but, for tolerance reasons, the upper limit of the first power range A1 is set to the second threshold value I₂ on the I_{PSCC} axis in FIG. 8.

In the power range A1, in which there is a relatively small to moderate feed-in power, i.e. for a relatively small to moderate maximum short-circuit current, the time difference between the period of time Δt_{ES} until the energy threshold value is reached and the turn-off duration Δt_{AS} of the outgoing feeder switch is so great that the tripping of the main switch can be delayed by at least the turn-off duration Δt_{AS} of the outgoing feeder switch. The arc fault protection system thus gives the outgoing feeder switch the time Δt_{W} to clear the fault in the case of F2 (=burning of an arc fault in the second protection area B2). In the case of F1 (=burning of an arc fault in the first protection area B1), the arc fault current is still present after 6 this waiting time Δt_{W}. The arc fault protection system will then activate the short-circuiting device in order to extinguish the arc fault F1. Thus, the arc fault protection system can distinguish between F1 and F2 and can guarantee selective shutdown. It must be noted that the arc fault energy until the end of the waiting time Δt_{W} plus the trun-off duration Δt_{AS} of the main switch must not exceed the energy threshold value E_{S} in order to rule out excessive damage to the installation.

In the power range A2, in which there is a relatively large feed-in power, the time difference between the period of time Δt_{ES} until the energy threshold value is reached and the turn-off duration Δt_{AS} of the outgoing feeder switch is so small that there is no time left for a decision between the main switch and an outgoing feeder switch. In this case, the current difference between the maximum arc fault current I_{LB,max} into the main distribution and the maximum forward current I_{AS,D} of the outgoing feeder switch is used as a criterion for selecting the arc fault current threshold value I_{S}. This means that the arc fault current threshold value I_{S} is selected to be between the maximum arc fault current I_{LB,max} into the main distribution and the maximum forward current I_{AS,D} of the outgoing feeder switch. In the case of F2 in the second protection area B2, the fault current is limited by the outgoing feeder switch upstream of the arc fault, with the result that the maximum forward current I_{AS,D} of the outgoing feeder switch is significantly lower than an arc fault current of F1 in the first protection area B1. This allows the arc fault protection system to distinguish between F1 and F2. The arc fault current threshold value I_{S} must be designed such that the period Δt_{S} until the arc fault current threshold value I_{S} is reached is less than the period Δt_{ES} until the energy threshold value E_{S} is reached plus the turn-off duration Δt_{AS} of the main switch.

The following variables and information should also be taken into account when designing the arc fault current threshold value Is:
The maximum possible arc fault current I_{LB,max} in the main distribution line on the basis of the feed-in power and grid impedance is estimated during the planning phase, see I_{LB,max} in FIG. 8.
The period Δt_{ES} until the maximum tolerable arc fault energy E_{S} is reached on the basis of the protection class, feed-in power and grid impedance is estimated during the planning phase, see Δt_{ES} in FIG. 7.
The maximum forward current I_{AS,D} and tripping duration Δt_{AS} of the outgoing feeder switch AS, see I_{AS,D} in FIG. 8 and Δt_{AS} in FIG. 7.
The arc fault current threshold value I_{S} depends on the feed-in power.
The arc fault current threshold value I_{S} must be less than the maximum arc fault current I_{LB,max} in the main distribution line, see FIG. 8.
The period of time Δ_{tS} until the arc fault current threshold value I_{S} is reached must be less than the period of time Δt_{ES} until the energy threshold value E_{S} is reached, see 26 FIG. 7.

FIG. 9 shows a P-t diagram of the period of time Δt_{ES} until the energy threshold value E_{S} is reached as a function of the feed-in power P4 at the feed-in point 4. The diagram illustrates that the time requirement for the speed at which the arc fault is extinguished increases with increasing feed-in power P4.

FIG. 10 shows a time line on which different times and time intervals are plotted with respect to the tripping of outgoing feeder and main switches. This is used to illustrate the different times and time intervals that play a role in determining the arc fault current threshold value I_{S}. In this case,
to is the time at which the arc fault ignites. The occurrence of an arc fault in the energy distribution installation is detected on the basis of current and/or voltage values in the main distribution line 1. This time to of detection is assumed to be the ignition time of the arc fault;
t1 is the time at which the arc fault reaches a certain current intensity I;
t2 is the time at which the outgoing feeder switch AS would trip if a current of the current intensity I has flowed through it since the time t1;
t3 is the time at which the waiting time Δt_{W} of the main switch HS, which was started at the time t1, ends;
t4 is the time at which the main switch HS trips and interrupts the current flow to the arc fault if it has received a corresponding trip command at the time t2;
t5 is the time at which the main switch HS trips and interrupts the current flow to the arc fault if it has received a corresponding trip command after the waiting time Δt_{W} has elapsed;
t6 is the time at which the energy E_{LB} released by the arc fault reaches a predefined energy threshold value E_{S};
Δt0 is the time interval between the ignition time to of the arc fault and the time t1 at which the arc fault reaches a certain current intensity I. Due to the rapid current increase in the arc fault, Δt0 is negligibly short;
Δt_{AS} is the outgoing feeder tripping duration of the outgoing feeder switch AS=time interval between t1 and t2;
Δt_{AS} is the shutdown duration of the main switch=time interval between t4 and t2=response time of the main switch=time interval between receiving a trip signal and reaching a state at which the current flow is interrupted;
Δt_{W} is the waiting time for which tripping of the main switch is delayed in order to give the outgoing feeder switches the opportunity to extinguish the arc fault;
Δt_{ES} is the time interval until the energy threshold value
E_{S} is reached=time interval between t1 and t6;
Δt_{M,0} is the tolerance by which the outgoing feeder tripping duration Δt_{AS} can be extended in order to obtain the waiting time Δt_{W} of the main switch HS=time interval between t5 and t6;
Δt_{M,1} is the tolerance that is still available for a selected waiting time Δt_{W} of the main switch HS before the time interval Δt_{ES} until the energy threshold value E_{S} is reached ends; and
Δt_{off,HS} is the time interval during which the main switch HS has interrupted the current to the arc fault after ignition of the arc fault=time interval between t1 and t5.

1-12. (canceled)

13. A method for protecting against arc faults in an electrical energy distribution installation in which electrical energy is distributed from an electrical feed-in point via a superordinate common main distribution line and from the superordinate common main distribution line via a plurality of subordinate outgoing feeder lines, wherein the superordinate common main distribution line is interrupted by a main switch and the subordinate outgoing feeder lines are each interrupted by an associated outgoing feeder switch, which comprises the step of:
matching an arc fault current threshold value to a maximum forward current and/or an outgoing feeder tripping duration of outgoing feeder switches such that an arc fault is extinguished either selectively by one of the outgoing feeder switches or by the main switch before energy released by the arc fault exceeds a predefined energy threshold value, an exceeding of the arc fault current threshold value by an arc fault current of the arc fault is a prerequisite for tripping the main switch.

14. The method according to claim 13, wherein the arc fault current threshold value is determined to be less than a maximum arc fault current in the superordinate common main distribution line.

15. The method according to claim 13, wherein:
the superordinate common main distribution line is interrupted by the main switch after a shutdown duration after receiving a shutdown command and the outgoing feeder switches are configured to trip according to a respective time/current characteristic curve of the outgoing feeder switches, which defines a relationship between the maximum forward current of the outgoing feeder switch and the outgoing feeder tripping duration of the outgoing feeder switch; and
in a first case, in which a sum of in each case the outgoing feeder tripping duration of the outgoing feeder switches and the shutdown duration of the main switch is less than a time interval until the predefined energy threshold value is reached, a waiting time, during which tripping of the main switch is blocked in order to give the outgoing feeder switches of the energy distribution installation an opportunity to selectively extinguish the arc fault, is determined to be at least as long as the outgoing feeder tripping duration and is also determined such that the energy released by the arc fault does not exceed the predefined energy threshold value.

16. The method according to claim 15, wherein the arc fault current threshold value and the waiting time are determined according to the respective time/current characteristic curve of the outgoing feeder switches and according to a time interval/electrical power characteristic curve, which defines a relationship between the time interval until the predefined energy threshold value and feed-in power at the feed-in point is reached.

17. The method according to claim 15, wherein, if, after the waiting time has elapsed, a current measured at the main switch is greater than the arc fault current threshold value of the main switch, the main switch is tripped.

18. The method according to claim 13, wherein:
The superordinate common main distribution line is interrupted by the main switch after a shutdown duration after receiving a shutdown command and the outgoing feeder switches are configured to trip according to a respective time/current characteristic curve of the outgoing feeder switches, which defines a relationship between the maximum forward current of the outgoing feeder switch and the outgoing feeder tripping duration of the outgoing feeder switch; and
in a second case, in which a sum of in each case the outgoing feeder tripping duration of the outgoing feeder switches and the shutdown duration of the main switch is greater than or equal to a time interval until the predefined energy threshold value is reached, the arc fault current threshold value is determined such that the arc fault current threshold value is greater than the maximum forward current of the outgoing feeder switches; and
the time interval until the arc fault current threshold value is reached is less than a time interval until the predefined energy threshold value is reached.

19. The method according to claim 18, wherein, in the second case, assuming that all of the outgoing feeder switches have current limitation, the main switch is tripped if a current measured at the main switch is greater than the arc fault current threshold value of the main switch.

20. The method according to claim 18, wherein, in the second case, assuming that at least one of the outgoing feeder switches do not have current limitation, the main switch is tripped if a current measured at the main switch is greater than the arc fault current threshold value of the main switch and a current measured at the outgoing feeder switches is not greater than a short-circuit tripping threshold of the outgoing feeder switches.

21. The method according to claim 20, wherein, if the current measured at one of the outgoing feeder switches is greater than the short-circuit tripping threshold of the one outgoing feeder switch, the one outgoing feeder switch sends a blockage signal to the main switch or to an arc fault protection unit controlling tripping of the main switch.

22. The method according to claim 13, wherein the arc fault is detected on a basis of electrical voltage and/or current values of the energy distribution installation.

23. An arc fault protection unit for an electrical energy distribution installation, the arc fault protection unit comprising:
an interface for receiving electrical voltage and/or current values of the electrical energy distribution installation and for sending signals to a main switch;
a data memory for storing a predefined arc fault current threshold value, above which the main switch is tripped; and
a processor configured to:
a) to detect an arc fault burning in the electrical energy distribution installation on a basis of the electrical voltage and/or current values of the electrical energy distribution installation; and
b) to trip the main switch only if an arc fault current of the arc fault measured at the main switch has exceeded the predefined arc fault current threshold value.

24. An electrical energy distribution installation, comprising an electrical feed-in point;
a superordinate common main distribution line connected to said electrical feed-in point;
a plurality of subordinate outgoing feeder lines coupled to said superordinate common main distribution line;
a main switch, wherein said superordinate common main distribution line being interrupted by said main switch;
outgoing feeder switches, wherein said subordinate outgoing feeder lines being interrupted by an associated one of said outgoing feeder switches;
at least one sensor for determining voltage and/or current values in said superordinate common main distribution line; and
said arc fault protection unit according to claim 23.
